(19) United States
(12) Patent Application Publication
(10) Pub. No.: US 2026/0225856 A1
(43) Pub. Date: Aug. 6, 2026

(54) HYDRAULIC ELEVATOR DRIVE SYSTEM AND ELEVATOR SYSTEM COMPRISING A HYDRAULIC ELEVATOR DRIVE SYSTEM

(71) Applicant: Otis Elevator Company, Farmington, CT (US)

(72) Inventors: Gianluca Foschini, Madrid (ES); Carlo Colombari, Sala Bolognese (IT)

(21) Appl. No.: 19/400,449

(22) Filed: Nov. 25, 2025

(30) Foreign Application Priority Data
Jan. 31, 2025 (EP) 25155432.5

(51) Int. Cl. B66B 11/04

(52) U.S. Cl. CPC B66B 11/0423

(57) ABSTRACT

A hydraulic drive system for driving an elevator system includes a fluid tank for storing a hydraulic fluid; a hydraulic fluid supply conduit that is configured for being fluidly coupled to a hydraulic cylinder of the elevator system; a fluid pump that is configured for pumping hydraulic fluid from the fluid tank into the hydraulic fluid supply conduit; an electric power supply circuit including at least one electric power storage device and configured for receiving single phase alternating current for charging the at least one electric power storage device and for selectively supplying electric power from the at least one electric power storage device to the fluid pump; a hydraulic fluid return conduit that is configured for being fluidly coupled to the hydraulic cylinder for returning hydraulic fluid from the hydraulic cylinder into the fluid tank; and an electric generator.

### FOREIGN PRIORITY

This application claims priority to European Patent Application No. 25155432.5, filed Jan. 31, 2025, and all the benefits accruing therefrom under 35 U.S.C. § 119, the contents of which in its entirety are herein incorporated by reference.

### TECHNICAL FIELD OF INVENTION

The invention relates to hydraulic drive system for driving an elevator car in an elevator system. The invention further relates to an elevator system comprising a hydraulic drive system and to a method of operating such an elevator system.

### BACKGROUND OF THE INVENTION

An elevator system typically comprises at least one elevator car that is configured for moving along a hoistway extending between a plurality of landings. The elevator system further comprises a drive system that is configured for driving the elevator car.

Hydraulic elevator systems are equipped with a hydraulic drive system comprising a telescopic support structure including a hydraulic cylinder and a piston that is mechanically coupled to the elevator car. The piston may be extended and the elevator car may be moved against gravity (e.g. upwards) by pumping a hydraulic fluid into the hydraulic cylinder. Due to their own weight, the piston will retract and the elevator car will move in direction of gravity (e.g. downwards) while discharging the hydraulic fluid from the hydraulic cylinder, when the hydraulic pressure applied to the hydraulic fluid is released.

A fluid pump is provided for pumping the hydraulic fluid into the hydraulic cylinder. A significant amount of electric power is needed for operating the fluid pump. Consequently, a conventional hydraulic elevator system needs to be connected to a high-capacity electric power supply, typically to a three-phase electric power supply, resulting in high installation costs. A conventional hydraulic elevator system further incurs high operational costs due to its significant electric power consumption.

### SUMMARY OF THE INVENTION

Accordingly, it would be beneficial to provide an improved hydraulic drive system for an elevator system that operates more efficiently and that may be connected to an electric power supply having less capacity.

According to an exemplary embodiment of the invention, a hydraulic drive system for an elevator system comprises a fluid tank for storing a hydraulic fluid; a hydraulic fluid supply conduit that is configured for being fluidly coupled to a hydraulic cylinder of the elevator system; a fluid pump that is configured for pumping hydraulic fluid from the fluid tank into the hydraulic fluid supply conduit; an electric power supply circuit for selectively supplying electric power to the fluid pump; a hydraulic fluid return conduit that is configured for being fluidly coupled to the hydraulic cylinder for returning hydraulic fluid from the hydraulic cylinder into the fluid tank; and an electric generator that is configured for generating electric power from hydraulic fluid flowing through the hydraulic fluid return conduit and for supplying the generated electric power to the electric power supply circuit. The electric power supply circuit comprises at least one electric power storage device. The electric power supply circuit is configured for receiving single phase alternating current from an external power supply for charging the at least one electric power storage device and for selectively supplying electric power from the at least one electric power storage device to the fluid pump.

Exemplary embodiments also include an elevator system comprising an elevator car that is configured for traveling along a hoistway between a plurality of landings, a hydraulic piston that is movably arranged in a hydraulic cylinder and mechanically coupled to the elevator car for driving the elevator car, and a hydraulic drive system according to an exemplary embodiment of the invention. The hydraulic fluid supply conduit and the hydraulic fluid return conduit of the hydraulic drive system are fluidly coupled to the hydraulic cylinder in order to allow for transferring hydraulic fluid from the fluid tank to the hydraulic cylinder and vice versa.

Exemplary embodiments further include a method of operating an elevator system according to an exemplary embodiment of the invention, wherein the method includes operating the fluid pump for conveying hydraulic fluid from the fluid tank through the hydraulic fluid supply conduit into the hydraulic piston for moving the elevator car against gravity (e.g. upwards); allowing hydraulic fluid from the hydraulic piston to flow back into the fluid tank through the hydraulic fluid return conduit when the elevator car moves by gravity (e.g. downwards); generating electric power by driving the electric generator with the hydraulic fluid flowing through the hydraulic fluid return conduit; and supplying the electric power generated by the electric generator to the electric power supply circuit of the hydraulic drive system, in particular to an electric power storage device of the hydraulic drive system.

The power demands of an elevator system fluctuate in the course of operation. The power demands of an elevator system are high when the elevator car is moved against gravity, in particular when the elevator car is elevated. These high power demands occur only temporarily when the elevator car is moved against gravity. The power demands of the elevator system are considerably lower when the elevator car is stationary, or when the elevator car is driven by its own weight, particularly when it is lowered, so that no power is needed for driving the elevator car and hydraulic pressure is released.

The electric power supply circuit of a hydraulic drive system according to an exemplary embodiment of the invention is able to satisfy the high temporary power demands of the fluid pump for moving the elevator car against gravity by supplying electric power from the at least one electric power storage device to the fluid pump.

When the elevator car is moved in direction of gravity or not moved at all, the at least one electric power storage device may be recharged with electric power that is supplied by an external power supply, in particular by a power grid. For the purposes of recharging, the external power supply does not need to accommodate the high temporary power demands that occur when the elevator car is moved against gravity.

In consequence, a hydraulic drive system according to an exemplary embodiment of the invention may be coupled to a conventional power grid having a lower power capacity compared to a conventional three-phase power grid. In particular, it is sufficient for the hydraulic drive system according to an exemplary embodiment of the invention to be coupled to a single phase electric power grid, and the site of the elevator system does not need to be equipped with a high-performance power grid, such as a three phase power grid. As a result, the costs for installing an elevator system comprising a hydraulic drive system may be reduced.

The electric power supply circuit of a hydraulic drive system according to an exemplary embodiment of the invention may be configured to prioritize delivering electric power to the fluid pump for extending the hydraulic piston and moving the elevator car against gravity from the at least one electric power storage device over supplying electric power to the fluid pump directly from other power sources, such as a power grid. Rather, electric power from other power sources, like a power grid, is used with priority, or even exclusively, for recharging the electric power storage device.

In addition, the at least one electric power storage device of a hydraulic drive system according to an exemplary embodiment of the invention allows for operating the hydraulic drive system for a limited amount of time even after the external power supply has been interrupted. This may be advantageous in emergency situations and/or in case the hydraulic drive system is connected to an unreliable external power supply/power grid.

Generating electric power from hydraulic fluid flowing through the hydraulic fluid return conduit when the elevator car is driven by gravity and supplying the generated electric power to the electric power supply circuit in order to be stored in the at least one electric power storage device allows for recuperating at least some of the energy that has been used before for rising the elevator car. Consequently, the overall power consumption for operating an elevator system according to an exemplary embodiment of the invention may be lowered and the operational costs may be reduced.

In the following, a number of further optional features of a hydraulic drive system according to exemplary embodiments of the invention are set out. These features may be realized in particular embodiments, alone or in combination with any of the other features, unless explicitly stated otherwise.

The hydraulic drive system may comprise a hydraulic fluid outlet valve that is arranged in the hydraulic fluid supply conduit. The hydraulic drive system may also comprise a hydraulic fluid return valve that is arranged in the hydraulic fluid return conduit. At least one of the hydraulic fluid outlet valve and the hydraulic fluid return valve may be a controllable valve or a one-way valve, respectively.

A controllable valve provided in a fluid conduit allows for controlling the movement of the elevator car by selectively opening and closing the respective valve. One-way valves may prevent an undesirable flow of hydraulic fluid from the hydraulic cylinder into the fluid tank through the hydraulic fluid supply conduit and/or an undesirable flow of hydraulic fluid from the fluid tank into the hydraulic cylinder through the hydraulic fluid return conduit, respectively.

The hydraulic fluid return conduit may be provided independently and separately from the hydraulic fluid supply conduit so that the hydraulic fluid flows only in one direction in each of the hydraulic fluid conduits, respectively.

Providing the hydraulic fluid supply conduit and the hydraulic fluid return conduit independently and separately from each other allows for a simple configuration of the valves that may be provided in the hydraulic fluid conduits for controlling the flow of hydraulic fluid through the hydraulic fluid conduits. It may further enhance the operational reliability of the elevator system since the hydraulic fluid may flow from the fluid tank into the hydraulic cylinder and back from the hydraulic cylinder into the fluid tank independently of each other. This may allow for moving the elevator car in at least one direction even if one of the hydraulic fluid conduits is broken or clogged.

The electric generator may comprise at least one turbine that is arranged in the hydraulic fluid return conduit for being driven by hydraulic fluid flowing through the hydraulic fluid return conduit. A turbine that is arranged in the hydraulic fluid return conduit allows for efficiently generating electric power from the hydraulic fluid flowing through the hydraulic fluid return conduit.

At least one of the fluid pump and the electric generator may be arranged in the fluid tank. At least one of the fluid pump and the electric generator may in particular be submerged in the hydraulic fluid stored in the fluid tank.

Arranging at least one of the fluid pump and the electric generator in the fluid tank allows for a space saving configuration of the hydraulic drive system. Submerging the fluid pump in the hydraulic fluid further allows for reducing or even eliminating any piping for supplying the hydraulic fluid from the fluid tank to the fluid pump.

The at least one electric power storage device may include at least one of a battery and a super capacitor. A battery may store a large amount of electric energy that may allow for operating the hydraulic drive system over a relatively long period of time without receiving electric energy from an external power supply. A super capacitor may be operated at relatively high electric voltages.

The described system integrates built-in emergency functions, as the use of a battery and/or supercapacitors allow the hydraulic elevator system to continue operating in the event of a power failure. The use of supercapacitors further improves energy efficiency because supercapacitors are able to store large current peaks even in very short moments.

The electric power supply circuit of the hydraulic drive system may comprise a rectifier that is configured for rectifying an alternating current, in particular a single phase alternating current, supplied to a DC intermediate circuit comprising the electric power storage device. The rectifier may in particular be configured for receiving single phase alternating current (AC) at a voltage in the range of between 110 V and 240 V, more particularly alternating current at a voltage of 115 V or at a voltage of 230 V.

Such a configuration allows for coupling the hydraulic drive system to a conventional single phase power grid that is available in many buildings. An elevator system comprising such a hydraulic drive system may in particular be installed in buildings that are not equipped with a high-performance three phase electric power supply.

The electric power supply circuit of the hydraulic drive system may comprise an inverter configured for converting electric power provided by the at least one electric power storage device, particularly power from the DC intermediate circuit, into alternating current that is supplied to an electric motor configured for driving the fluid pump. The inverter may in particular be configured for providing three phase alternating current.

Electric motors that operate with three-phase alternating current are highly efficient and require minimal maintenance.

In order to allow for adjusting the travel speed of the elevator car, the hydraulic drive system may comprise a controller for controlling the inverter adjust the pumping capacity of the fluid pump by controlling the operation of the inverter.

In particular, the controller may be configured to control the inverter in such a manner as to keep the duration of acceleration phases and/or deceleration phases of the elevator car at a constant level, irrespective of operating conditions. Adjusting constant acceleration phases and deceleration phases at all times significantly reduces the production of heat and thus energy to be dissipated during transient phases of elevator operation, such as phases of acceleration and/or deceleration of the elevator car.

Consequently, employing of a controllable inverter, as proposed according to the present embodiment, provides a particular advantage in a hydraulic elevator, as this measure avoids the need for providing additional measures allowing dissipation of heat, like fluid resistors, for maintaining the temperature of the hydraulic fluid within the desired range even in case of longer periods of acceleration and/or deceleration.

A method of operating an elevator system according to an exemplary embodiment of the invention may include controlling the speed of the elevator car by controlling the electric power supplied to the fluid pump. The method may in particular include controlling the adjustable inverter for adjusting the electric power supplied to the fluid pump.

Adjusting the travel speed of the elevator car by controlling the inverter allows for moving the elevator car very efficiently. Adjusting the travel speed of the elevator car by controlling the inverter may in particular be significantly more efficient than operating the fluid pump at constant speed and adjusting the travel speed of the elevator car by bypassing a portion of the hydraulic fluid that is conveyed by the fluid pump by the hydraulic cylinder.

In consequence, the travel times of the elevator car as well as the energy consumption of the elevator system may be reduced.

By adjusting the travel speed of the elevator car by controlling the operation of the inverter, the requirements for the viscosity of the hydraulic fluid can be reduced. As a result, heating the hydraulic fluid in order to achieve a required viscosity may not be necessary.

The DC intermediate circuit of the hydraulic drive system may further comprise a DC/DC-voltage converter that is electrically connected between the electric power storage device and the inverter. The electric generator may in particular be electrically coupled via an AC/DC voltage converter to an input side of the DC/DC-voltage converter. A method of operating an elevator system according to an exemplary embodiment of the invention may include employing a DC/DC converter to modify the voltage of the electric power supplied by the electric generator.

The DC/DC-voltage converter may, for example, be configured for converting an electric DC voltage from 48 or 96 V to 565 V.

A DC/DC-voltage converter allows for operating the inverter and the electric motor with a higher electric voltage than the at least one electric storage device. This may allow for operating the inverter and the electric motor more efficiently.

Depending on the electric voltage supplied by the electric generator the electric generator may be electrically coupled to an input side or to an output side of the DC/DC-voltage converter.

In the hydraulic drive system the electric power storage device may comprise a first electric power storage device connected in between an output side of the rectifier and an input side of the DC/DC voltage converter and a second power storage device connected to an output side of the DC/DC voltage converter.

The additional features, modifications, and effects described above in relation to a hydraulic drive system according to exemplary embodiments of the invention apply analogously to an elevator system comprising a hydraulic drive system and to a method of operating such an elevator system.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIG. 2 depicts a schematic view of the hydraulic drive system according to an exemplary embodiment of the invention.

### DETAILED DESCRIPTION OF THE INVENTION

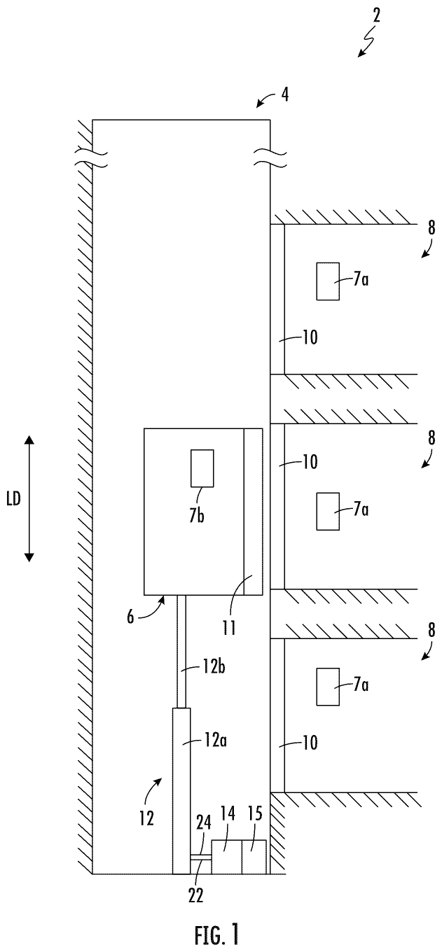

FIG. 1 schematically depicts an elevator system 2 according to an exemplary embodiment of the invention.

The elevator system 2 comprises a hoistway 4 extending along a longitudinal direction LD, in particular a vertical direction, between a plurality of landings 8 located on different floors.

The elevator system 2 includes an elevator car 6 that is arranged in the hoistway 4 for being moved along the longitudinal direction LD between the plurality of landings 8. The elevator car 6 may in particular be movable along at least one guide rail that is provided in the hoistway 4 extending along the longitudinal direction LD. Such a guide rail is not depicted in FIG. 1.

A landing door 10 is provided at each of the landings 8. The elevator car 6 is provided with a corresponding elevator car door 11 for allowing passengers to transfer between one of the landings 8 and the interior of the elevator car 6, when the elevator car 6 is positioned at the respective landing 8.

The elevator car 6 is supported by a telescopic support structure 12. The telescopic support structure 12 comprises a hydraulic cylinder 12a extending in the longitudinal direction LD and a piston 12b. The piston 12b is arranged in the hydraulic cylinder 12a in a configuration in which it is movable along the longitudinal direction LD.

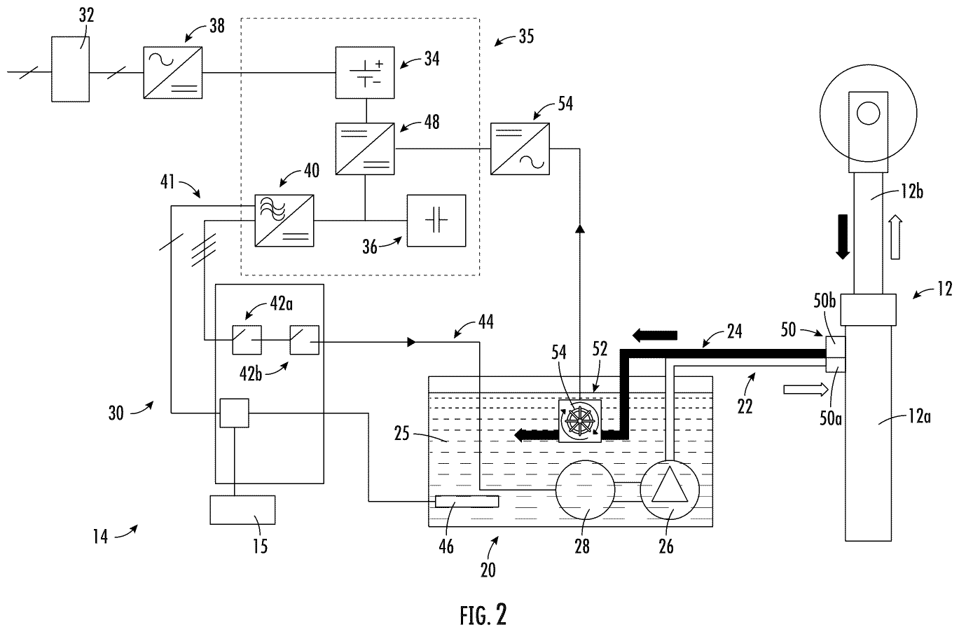

The piston 12b may in particular be moved upwards by pumping a hydraulic fluid 25 (see FIG. 2) into the hydraulic cylinder 12a.

In further embodiments that are not explicitly depicted in the figures, the telescopic support structure 12 may comprise a plurality of pistons 12b that are movably arranged within each other for extending the operational range of the telescopic support structure 12.

The elevator system 2 further comprises a hydraulic drive system 14 that is fluidly coupled to the hydraulic cylinder 12a by hydraulic fluid conduits 22, 24. The hydraulic drive system 14 is configured for selectively pumping the hydraulic fluid 25 into the hydraulic cylinder 12a for elevating the elevator car 6 and for draining the hydraulic fluid 25 from the hydraulic cylinder 12a in order to allow the elevator car 6 to move downwards driven by its own weight.

The hydraulic drive system 14 may be controlled by an elevator controller 15.

The elevator system 2 may be a machine room-less elevator system 2, as it is depicted in FIG. 1, in which the hydraulic drive system 14 and the elevator controller 15 are arranged in the hoistway 4, in particular at the bottom of the hoistway 4.

In an alternative embodiment that is not explicitly depicted in the figures, the hydraulic drive system 14 and the elevator controller 15 may be arranged in a machine room that is separated from the hoistway 4.

Input to the elevator controller 15 may be provided via landing control panels 7a provided on every landing 8, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled with the elevator controller 15 by means of electrical wiring not shown in FIG. 1, in particular by an electric bus, or by wireless data connections.

FIG. 2 depicts an enlarged schematic view of the hydraulic drive system 14.

The hydraulic drive system 14 comprises a fluid tank 20 storing a hydraulic fluid 25. The fluid tank 20 is fluidly coupled to the hydraulic cylinder 12a by two hydraulic fluid conduits 22, 24.

The two hydraulic fluid conduits 22, 24 are formed separately from each other. The hydraulic fluid conduits 22, 24 include in particular a hydraulic fluid supply conduit 22 that is configured for allowing hydraulic fluid 25 to flow from the fluid tank 20 into the hydraulic cylinder 12a, and a hydraulic fluid return conduit 24 that is configured for allowing hydraulic fluid 25 to flow from the hydraulic cylinder 12a back into the fluid tank 20.

The hydraulic drive system 14 further comprises a fluid pump 26 that is configured for pumping the hydraulic fluid 25 from the fluid tank 20 through the hydraulic fluid supply conduit 22 into the hydraulic cylinder 12a for elevating the elevator car 6 coupled to the piston 12b (cf. FIG. 1). The elevator car 6 is not depicted in FIG. 2.

The fluid pump 26 is driven by an electric motor 28. The fluid pump 26 and the electric motor 28 may be arranged in the fluid tank 20. The fluid pump 26 and the electric motor 28 may in particular by submerged in the hydraulic fluid 25 stored in the fluid tank 20, as it is depicted in FIG. 2.

The hydraulic drive system 14 further comprises an electric power supply circuit 30 that is configured for controlling the operation of the fluid pump 26 by selectively supplying electric power to the electric motor 28 driving the fluid pump 26.

The hydraulic drive system 14 is in particular configured for receiving single phase alternating current (AC) from an external power supply 32, for example from a single phase power grid providing electric power at a voltage in the range of between 110 V and 240 V. The external power supply 32 may in particular be configured for supplying single phase alternating current at a voltage of 115 V or at a voltage of 230 V.

The hydraulic drive system 14 is further configured for supplying three phase alternating current, in particular three phase alternating current at a voltage in the range of between 230 Vac and 400 Vac at frequencies of up to 50 Hz, to the electric motor 28.

Such an electric power supply circuit 30 allows for operating the elevator system 2 with electric power provided by a common single phase power grid, as it is typically available in every building.

The electric power supply circuit 30 comprises a DC intermediate circuit 35 comprising at least one electric power storage device 34, 36, such as a battery 34 and/or a super capacitor 36, configured for storing electric power. The at least one electric power storage device 34, 36 operates at direct current voltages and provides DC currents.

The electric power supply circuit 30 further comprises a charging circuit 38 including a rectifier that is configured for receiving single phase alternating current (AC) from the external power supply 32 and for providing direct current (DC) for charging the at least one electric power storage device 34, 36.

The DC intermediate circuit 35 further comprises an inverter 40 that is configured for converting the direct current (DC) electric power provided by the at least one electric power storage device 34, 36 into three phase alternating current for driving the electric motor 28 of the fluid pump 26.

The inverter 40 may be controllable in order to allow for controlling the movement of the hydraulic cylinder 12a that is mechanically coupled to the elevator car 6 by controlling the operation of the fluid pump 26 via the three phase alternating current supplied to the electric motor 28.

Controlling the movement of the hydraulic cylinder 12a and the elevator car 6 by controlling the supply of electric energy from the inverter 40 to the electric motor 28 of the fluid pump 26 may be significantly more efficient than a conventional approach in which the fluid pump 26 is directly connected to the external power supply 32 for operating with constant speed, and the movement of the elevator car 6 is controlled by selectively opening a hydraulic bypass for allowing at least a portion of the hydraulic fluid 25 from the fluid pump 26 to bypass the hydraulic cylinder 12a in order to reduce the speed of the upward movement of the elevator car 6.

An electric power supply line 44 coupling the output side of the inverter 40 with the electric motor 28 may comprise one or more electric power switches 42a, 42b in order to allow for selectively connecting and disconnecting the inverter 40 and the electric motor 28.

The inverter 40 may additionally comprise an additional electric output 41 providing single phase electric current for operating further components of the elevator system 2. Such components may include the elevator controller 15, lights (not shown) in the elevator car 6 and/or at least one electric heater 46 that is provided in the fluid tank 20 for heating the hydraulic fluid 25.

The battery 34 of the electric power supply circuit 30 may be configured for operating at a different voltage than the inverter 40 and the optional super capacitor 36.

In such a configuration, the DC intermediate circuit 35 may comprise a DC/DC-voltage converter 48 that is electrically coupled to the battery 34 and to the input side of the inverter 40. The DC/DC-voltage converter 48 may further be coupled to the super capacitor 36, if present.

The DC-voltage converter may, for example, be configured for converting electric DC power from 48 or 96 V to 565 V.

The hydraulic drive system 14 further comprises the hydraulic fluid return conduit 24 fluidly coupling the hydraulic cylinder 12b with the fluid tank 20 in order to allow for lowering the elevator car 6 by allowing hydraulic fluid 25 to flow from the hydraulic cylinder 12b into the fluid tank 20.

A valve unit 50 comprising one or more valves 50a, 50b may be provided at or within the hydraulic fluid conduits 22, 24 in order to allow for controlling the flow of hydraulic fluid 25 from the fluid tank 20 into the hydraulic cylinder 12a and vice versa.

The valve unit 50 may comprise automatically operating one-way valves 50a, 50b that allow hydraulic fluid to flow through the hydraulic fluid conduits 22, 24 in only one predefined direction, respectively.

The valve unit 50 may also comprise controllable valves 50a, 50b that are selectively controllable by the elevator controller 15.

Providing the hydraulic fluid supply conduit 22 and the hydraulic fluid return conduit 24 separately from each other allows for a simple configuration of the valve unit 50 since the valves 50a, 50b for each of the hydraulic fluid conduits 22, 24 may be provided and controlled separately and independently of each other.

Providing the hydraulic fluid supply conduit 22 and the hydraulic fluid return conduit 24 separately from each other may further enhance the operational reliability of the elevator system 2 since the hydraulic fluid 25 may flow from the fluid tank 20 into the hydraulic cylinder 12a and back from the hydraulic cylinder 12a into the fluid tank 20 independently of each other. This may allow for moving the elevator car 6 in at least one direction even if one of the hydraulic fluid conduits 22, 24 is broken or clogged.

The hydraulic drive system 14 further comprises an electric generator 52 including a turbine 54 that is arranged at or within the hydraulic fluid return conduit 24 in order to be driven by hydraulic fluid 25 flowing from the hydraulic cylinder 12a into the fluid tank 20 through the hydraulic fluid return conduit 24.

The electric generator 52 may in particular by submerged in the hydraulic fluid 25 stored in the fluid tank 20, as it is depicted in FIG. 2.

The electric current generated by the electric generator 52 may be supplied to the electric power supply circuit 30, where it may be rectified by a rectifier 56 and used for charging the battery 34 and/or the super capacitor 36.

Depending on the voltage of the electric power supplied by the electric generator 52, the output side of the rectifier 56 may be electrically coupled to the low voltage input side or to the high voltage output side of the DC/DC-voltage converter 48.

Providing an electric generator 52 at or in the hydraulic fluid return conduit 24 allows for recuperating electric energy for charging the at least one electric power storage device 34, 36 when the elevator car 6 is lowered. Consequently, the overall power consumption and, as a result, the operational costs of the elevator system 2 may be reduced.

While the invention has been described with reference to exemplary embodiments, it will be understood by those skilled in the art that various changes may be made and equivalents may be substituted for elements thereof without departing from the scope of the invention. In addition, many modifications may be made to adopt a particular situation or material to the teachings of the invention without departing from the essential scope thereof. Therefore, the invention is not intended to be limited to the specific embodiments disclosed, but to encompass all embodiments within the scope of the appended claims.

What is claimed is:

1. Hydraulic drive system (14) for driving an elevator system (2), the hydraulic drive system (14) comprising:
a fluid tank (20) for storing a hydraulic fluid (25);
a hydraulic fluid supply conduit (22) that is configured for being fluidly coupled to a hydraulic cylinder (12a) of the elevator system (2);
a fluid pump (26) that is configured for pumping hydraulic fluid (25) from the fluid tank (20) into the hydraulic fluid supply conduit (22);
an electric power supply circuit (30) comprising at least one electric power storage device (34, 36) and configured for receiving single phase alternating current for charging the at least one electric power storage device (34, 36) and for selectively supplying electric power from the at least one electric power storage device (34, 36) to drive the fluid pump (26);
a hydraulic fluid return conduit (24) that is configured for being fluidly coupled to the hydraulic cylinder (12a) for returning hydraulic fluid (25) from the hydraulic cylinder (12a) into the fluid tank (20); and
an electric generator (52) that is configured for generating electric power from hydraulic fluid (25) flowing through the hydraulic fluid return conduit (24) and for supplying the generated electric power to the electric power supply circuit (30).

2. Hydraulic drive system (14) according to claim 1, wherein the hydraulic fluid return conduit (24) is provided separately from the hydraulic fluid supply conduit (22).

3. Hydraulic drive system (14) according to claim 1, wherein the electric power supply circuit (30) is configured for prioritizing supply of electric power to drive the fluid pump (26) by energy stored in the at least one energy storage device (34, 36) over supply of electric power directly from other power sources, particularly from a power grid.

4. Hydraulic drive system (14) according to claim 1, wherein the electric generator (52) comprises at least one turbine (54) that is arranged in the hydraulic fluid return conduit (24) for being driven by hydraulic fluid (25) flowing through the hydraulic fluid return conduit (24).

5. Hydraulic drive system (14) according to claim 1, further comprising a hydraulic fluid outlet valve (50a) in the hydraulic fluid supply conduit (22) and/or a hydraulic fluid return valve (50b) in the hydraulic fluid return conduit (24);
wherein at least one of the hydraulic fluid outlet valve (50a) and the hydraulic fluid return valve (50b) is in particular a controllable valve or a one-way valve.

6. Hydraulic drive system (14) according to claim 1,
wherein at least one of the fluid pump (26) and the electric generator (52) is arranged in the fluid tank (20);
wherein at least one of the fluid pump (26) and the electric generator (52) is in particular submerged in the hydraulic fluid (25) stored in the fluid tank (20).

7. Hydraulic drive system (14) according to claim 1, wherein the at least one electric power storage device (34, 36) includes at least one of a battery (34) and a super capacitor (36).

8. Hydraulic drive system (14) according to claim 1, wherein the electric power supply circuit (30) comprises a rectifier (38) that is configured for rectifying the single phase alternating current supplied to the electric power supply circuit (30) and charging a DC intermediate circuit (35) comprising the at least one electric power storage device (34, 36), wherein the rectifier (38) is in particular configured for receiving single phase alternating current at a voltage in the range of between 110 V and 240 V, more particularly alternating current at a voltage of 115 V or at a voltage of 230 V.

9. Hydraulic drive system (14) according to claim 1, wherein the electric power supply circuit (30) comprises an inverter (40) that is configured for converting electric power provided by the at least one electric power storage device (34, 36) into alternating current for driving the fluid pump (26), wherein the inverter (40) is in particular configured for providing three phase alternating current.

10. Hydraulic drive system (14) according to claim 8, comprising a controller for controlling the inverter (40) to adjust the pumping capacity of the fluid pump (26) by controlling the operation of the inverter (40); wherein the inverter is in particular controlled in such a manner as to keep the duration of acceleration phases and/or deceleration phases of the elevator car at a constant level.

11. Hydraulic drive system (14) according to claim 8, wherein the DC intermediate circuit (35) further comprises a DC/DC-voltage converter (48) that is connected between the electric power storage device (34) and the inverter (40), wherein the electric generator (52) is in particular electrically coupled via an AC/DC voltage converter (54) to an input side of the DC/DC-voltage converter (48).

12. Hydraulic drive system (14) according to claim 11, wherein the electric power storage device (34, 36) comprises a first electric power storage device (34) connected in between an output side of the rectifier (38) and an input side of the DC/DC voltage converter (48) and a second power storage device (36) connected to an output side of the DC/DC voltage converter (48).

13. Hydraulic drive system (14) according to claim 11, wherein the DC-voltage converter (48) is configured for converting electric DC power from 48 or 96 V to 565 V.

14. Elevator system (2) comprising
an elevator car (6) that is configured for traveling along a hoistway (4) between a plurality of landings (8);
a hydraulic piston (12b) that is movably arranged in a hydraulic cylinder (12a) and coupled to the elevator car (6) for driving the elevator car (6); and
a hydraulic drive system (14) according to claim 1, wherein the hydraulic fluid supply conduit (22) and the hydraulic fluid return conduit (24) are fluidly coupled to the hydraulic cylinder (12a) in order to allow for transferring hydraulic fluid (25) between the fluid tank (20) and the hydraulic cylinder (12a).

15. Method of operating an elevator system (2) according to claim 14, wherein the method includes:
operating the fluid pump (26) for conveying hydraulic fluid (25) from the fluid tank (20) through the hydraulic fluid supply conduit (22) into the hydraulic piston (12b) for moving the elevator car (6) against gravity;
allowing hydraulic fluid (25) from the hydraulic piston (12b) to flow back into the fluid tank (20) through the hydraulic fluid return conduit (24) when the elevator car (6) moves driven by gravity;
generating electric power by driving the electric generator (52) with the hydraulic fluid (25) flowing through the hydraulic fluid return conduit (24); and
supplying the electric power generated by the electric generator (52) to the electric power supply circuit (30) of the hydraulic drive system (14), in particular to an electric power storage device (34, 36) of the hydraulic drive system (14) wherein particularly the method further includes employing a DC/DC converter (48) to change the voltage of the electric power supplied by the electric generator (52); and/or wherein the method particularly further includes controlling the speed of the elevator car (6) by controlling the electric power supplied to the fluid pump (26); wherein the method in particular includes controlling an adjustable inverter (40) for adjusting the electric power supplied to the fluid pump (26).
